(19) United States
(12) Patent Application Publication
(10) Pub. No.: US 2022/0243668 A1
(43) Pub. Date: Aug. 4, 2022

(54) FAULT DETECTION OF A FUEL CONTROL UNIT

(71) Applicant: PRATT & WHITNEY CANADA CORP., Longueuil (CA)

(72) Inventor: Jagoda KRZYWON, Longueuil (CA)

(21) Appl. No.: 17/164,358

(22) Filed: Feb. 1, 2021

(51) Int. Cl. F02C 9/46; F02C 7/232; F02C 9/36

(52) U.S. Cl. CPC F02C 9/46; F02C 7/232; F02C 9/36; F05D 2220/323; F05D 2270/304; F05D 2270/09; F05D 2270/3032; F05D 2270/335; F05D 2260/80

(57) ABSTRACT

Methods and systems for fault detection of a fuel control unit of an engine are provided. Exceedance of at least one engine parameter beyond a safety threshold, associated with excessive fuel flow to the engine, is detected at an engine controller associated with the engine. The fuel control unit is commanded, via the engine controller, to implement a reduction in the fuel flow to the engine. Following the commanding of the fuel control unit, subsequent exceedance of the at least one engine parameter beyond the safety threshold is detected at the engine controller. A fault of the fuel control unit is determined at the engine controller, based on the subsequent exceedance. In response to determining the fault of the fuel control unit, at least one countermeasure to the fault of the fuel control unit is triggered by the engine controller.

### TECHNICAL FIELD

The application relates generally to combustion engines and, more particularly, to fuel control units of combustion engines

### BACKGROUND OF THE ART

In aircraft engines, continuous inlet air is compressed, mixed with fuel in an inflammable proportion, and exposed to an ignition source to ignite the mixture which then continues to burn to produce combustion products. The combustion of the air-fuel mixture can be used to power various mechanical components, which in turn can be used to produce thrust or other mechanical force.

Control of the flow of fuel to an aircraft engine offers a primary control mechanism for regulating the operation of the engine. For example, increasing the flow of fuel may result in an increase in output power of the engine, and thus an increase in thrust. Control of engine fuel flow may be performed by or as part of a dedicated controller, such as a fuel control unit. Failure or malfunction of the fuel control unit, resulting in an inability to regulate fuel flow to the engine, may produce adverse consequences for the engine.

While existing countermeasures to failed fuel control units are suitable for their purposes, improvements remain desirable.

### SUMMARY

In accordance with a first broad aspect, there is provided a method for fault detection of a fuel control unit of an engine. The method comprises: detecting, at an engine controller associated with the engine, exceedance of at least one engine parameter beyond a safety threshold associated with excessive fuel flow to the engine; commanding, via the engine controller, the fuel control unit to implement a reduction in the fuel flow to the engine; following the commanding of the fuel control unit to implement the reduction in the fuel flow to the engine, detecting, at the engine controller, subsequent exceedance of the at least one engine parameter beyond the safety threshold; determining, at the engine controller based on the subsequent exceedance, a fault of the fuel control unit; and in response to determining the fault of the fuel control unit, triggering, by the engine controller, at least one countermeasure to the fault of the fuel control unit.

In accordance with another broad aspect, there is provided a system for fault detection of a fuel control unit of an engine. The system comprises a processing unit and a non-transitory computer-readable medium. The non-transitory computer-readable medium has stored thereon program instructions which are executable by the processing unit for causing the system to perform: detecting, at an engine controller associated with the engine, exceedance of at least one engine parameter beyond a predetermined associated threshold; commanding, via the engine controller, the fuel control unit to implement a reduction in fuel flow to the engine; following the commanding of the fuel control unit to implement the reduction in the fuel flow to the engine, detecting, at the engine controller, subsequent exceedance of the at least one engine parameter beyond the predetermined associated threshold; determining, at the engine controller based on the subsequent exceedance, a fault of the fuel control unit; and in response to determining the fault of the fuel control unit, issuing, by the engine controller, a signal to trigger at least one countermeasure to the fault of the fuel control unit.

Features of the systems, devices, and methods described herein may be used in various combinations, in accordance with the embodiments described herein. In particular, any of the features described herein may be used alone, together in any suitable combination, and/or in a variety of arrangements, as appropriate.

### DESCRIPTION OF THE DRAWINGS

Reference is now made to the accompanying figures in which:

FIG. 1 is a schematic cross sectional view of an example gas turbine engine;

FIG. 2 is block diagram representation of an example fuel delivery system of the aircraft engine of FIG. 1;

FIGS. 3A-C are block diagram representations of example fuel control units of the fuel delivery system of FIG. 2;

FIGS. 4 to 6 are schematic diagrams of example fuel delivery systems;

FIG. 7 is a block diagram representation of an example computing device; and

FIG. 8 is a flowchart illustrating an example method for fault detection of a fuel control unit of an engine.

It will be noted that throughout the appended drawings, like features are identified by like reference numerals.

### DETAILED DESCRIPTION

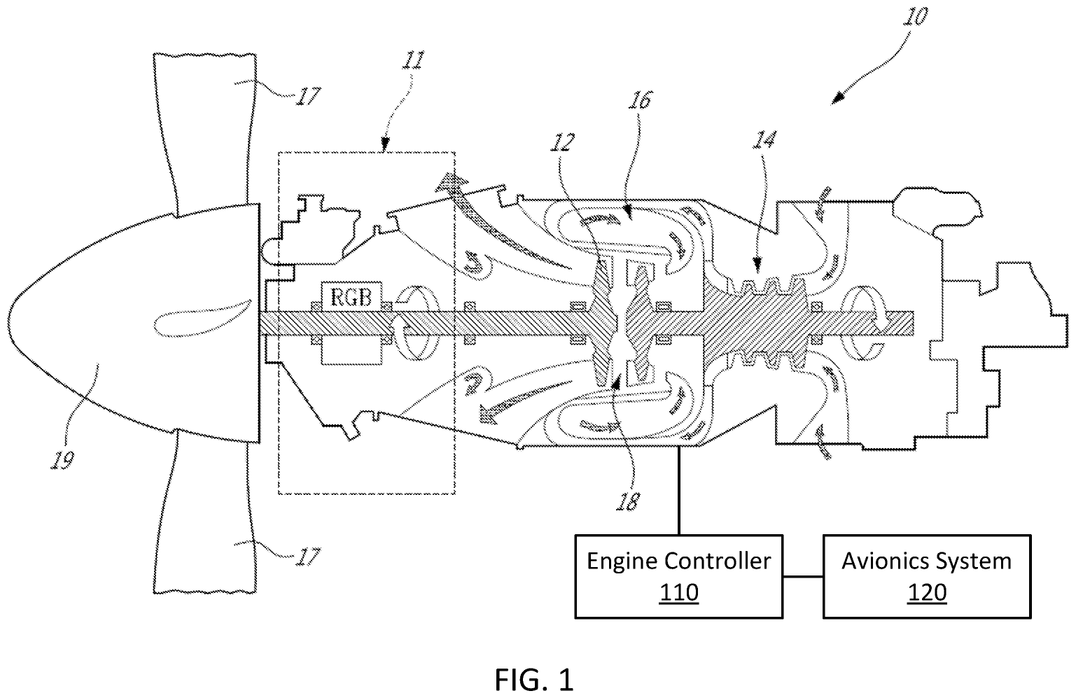

FIG. 1 illustrates a gas turbine engine 10 of a type preferably provided for use in subsonic flight, generally comprising in serial flow communication a compressor section 14 for pressurizing ambient air, a combustor 16 in which the compressed air is mixed with fuel and ignited for generating an annular stream of hot combustion gases, and a turbine section 18 for extracting energy from the combustion gases. A low pressure (LP) turbine 12 drives, via a reduction gear box (RGB), a propeller 19 having propeller blades 17 for providing thrust to the aircraft. An oil system 11 is provided for the gas turbine engine 10, and provides lubrication for the rotating components of the gas turbine engine 10, which include bearings for the rotating turbomachinery (e.g. the compressors, turbines, shafts, and gears), the RGB and the propeller control systems, etc.

FIG. 1 illustrates the engine 10 as a gas turbine engine of an aircraft. It should, however, be understood that the engine 10 may include any other suitable type of engine, such as a piston engine, a turboshaft engine, a turbofan engine, a rotary engine, for instance a Wankel engine, any other suitable type of combustion engine, and the like. In addition, although the various embodiments and examples provided in the present disclosure relate primarily to flight applications in which an engine (e.g., the engine 10) provides thrust for an aircraft, it should be understood that other fields of application, including in industrial settings, power generation setting, and the like, are also considered.

As illustrated in FIG. 1, an engine controller 110 is coupled to the engine 10 for controlling operation of the engine 10. The engine controller 110 is coupled to an avionics system 120, which may be associated with an aircraft of which the engine 10 forms part. The avionics system may include a variety of sensors, controllers, input and output devices, including display devices, and the like, in order to allow an operator of the aircraft to control the operation thereof. The display device(s) forming part of the avionics system 120 may also serve to display information to the operator.

In some embodiments, the avionics system 120 is configured for conveying commands from the operator of the aircraft to the engine controller 110, which in turn then issues commands to the engine 10 and any related components. In some embodiments, the engine controller 110 and the avionics system 120 are communicatively coupled via one or more electrical, optical, and/or electromagnetic communication channels. In some other embodiments, the engine controller 110 and the avionics system 120 may be communicatively coupled via one or more hydraulic and/or mechanical communication channels. In some further embodiments, the coupling between the engine controller 110 and the avionics system 120 is effected by any suitable combination of the above. For example, one or more electrical wires, cables, or the like couple the engine controller 110 to the avionics system 120.

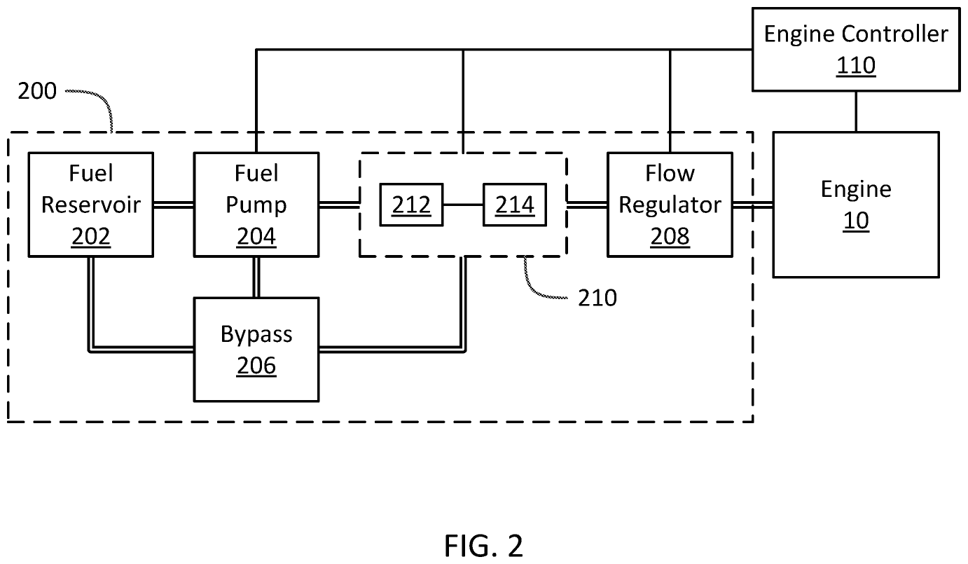

With reference to FIG. 2, a fuel delivery system 200, which provides fuel to the engine 10, is illustrated. The fuel delivery system 200 is composed of a fuel reservoir 202, a fuel pump 204, a bypass 206, a fuel control unit (FCU) 210, and a flow distributor 208. The fuel reservoir 202 stores a quantity of fuel, which may be a petroleum-based fuel or another type of fuel, as appropriate, and provides the fuel to the remainder of the fuel delivery system 200. In some cases, the fuel reservoir 202 includes a central or main fuel tank, and in some other cases, the fuel reservoir 202 includes one or more auxiliary fuel tanks, one or more distributed fuel tanks, or the like. The fuel reservoir 202 is coupled to the fuel pump 204, which is operable to extract fuel from the fuel reservoir 202 when activated. The fuel pump 204 may be controlled by way of the engine controller 110, or by way of another element of the fuel delivery system 200, for instance the FCU 210. The fuel reservoir 202 is also coupled to the bypass 206, which serves to account for excess fuel supply provided to the fuel pump 204 and/or to the FCU 210. The bypass 206 may include any suitable number of relief valves or similar components operable to convey excess fuel from the fuel pump 204 and/or from the FCU 210 to the fuel reservoir 202.

The FCU 210 serves to measure the amount of fuel provided to the engine 10, and is controllable by the engine controller 110 to regulate the operation of the engine 10 by controlling the fuel flow to the engine 10. The flow distributor 208, located between and coupled to the FCU 210 and the engine 10, performs additional distribution of fuel flow, including to fuel manifolds, and can assist in purging fuel from fuel manifolds of the engine 10 during engine shutdown.

The FCU 210 may be composed of a variety of valves, control elements (e.g. solenoids), and other suitable devices for regulating the fuel flow to the engine 10. In some embodiments, the FCU 210 is composed of a flow metering valve 212 and a relief device 214. In some other embodiments, the FCU 210 may include other elements of the fuel delivery system 200, such as the fuel pump 204 and/or the flow distributor 208. For example, the engine controller 110 may be communicatively coupled to the FCU 210 for issuing commands to the FCU 210, and the FCU 210 may in turn issue commands and/or control the operation of the fuel pump 204, and/or the flow distributor 208, in addition to controlling operation of the flow metering valve 212 and the relief device 214. Alternatively, or in addition, part or all of the operation of the FCU 210, the fuel pump 204, and/or the flow distributor 208 may be performed mechanically, pneumatically, or in any other suitable fashion, for instance on the basis of the RGB of the engine 10. The RGB of the engine 10 may be controlled by the engine controller 110, or may in turn be controlled mechanically, pneumatically, or the like, on the basis of a further device intermediary the RGB and the engine controller 110.

The flow metering valve 212 is a controllable valve which regulates the amount of fuel flowing to the engine 10. The flow metering valve 212 may be controlled by the engine controller 110, or via a local controlling element forming part of the FCU 210 which receives commands from the engine controller 110. In some embodiments, the flow metering valve 212 is controllable by way of the actuation of one or more solenoids which, when energized, alter the operation of the flow metering valve 212. In some other embodiments, other types of valves are used to implement the flow metering valve 212. The flow metering valve 212 is fluidically coupled to the relief device 214, such that the relief device 214 may be operated to implement one or more countermeasures in response to failure of the flow metering valve 212. In some embodiments, the relief device 214 may be a controllable valve of any suitable type, and may resemble, or differ from, the flow metering valve 212. In some other embodiments, the relief device 214 may be a controllable drain coupled to, or forming part of, the metering valve 212.

In operation, the engine controller 110, whether directly or via an intermediary device, controls operation of the fuel delivery system 200, including the operation of the FCU 210. The engine controller 110 may instruct the FCU 210 to alter the flow of fuel to the engine 10. By way of an example, the engine controller 110 alters the fuel flow to the engine 10 in response to commands received from an operator, for instance via the avionics system 210. By way of another example, the engine controller 110 alters the fuel flow to the engine 10 in response to detecting particular states, or changes in state, of the engine 10. For instance, if an output power of the engine 10 falls below a requested output power, the engine controller 110 can automatically request an increase in the fuel flow to the engine 10 by operating the FCU 210. It should be noted that the engine controller 110 may also alter the operation of other elements of the engine 10, as appropriate.

It may occur that the flow metering valve 212 malfunctions or fails, resulting in a loss of control over the fuel flow to the engine 10. Various types of failure of the flow metering valve 212 may occur, such as blockage, breakdown, aging, loss of connectivity to the engine controller 110, and the like. In some cases, failure of the flow metering valve 212 may result in an uncontrollable flow of fuel to the engine 10, which may result in the engine 10 receiving a maximum or rated fuel flow, or a fuel flow above a requested fuel flow. In some other cases, failure of the flow metering valve 212 may result in limited control over the flow of fuel to the engine 10, which may result in longer response times to commands to alter the fuel flow to the engine 10, or an inability of the FCU 210 to achieve certain levels of fuel flow. For example, failure of the flow metering valve 212 may result in undesirably-high fuel flow to the engine, i.e., fuel flow above a commanded fuel flow level. This may result in the engine 10 operating outside of a safe operating envelope, experiencing overspeed conditions and/or excessive acceleration, and the like. As a result, the FCU 210 is provided with the relief device 214, which can be used to compensate for malfunction or failure of the flow metering valve 212.

In some embodiments, detection of failure of the flow metering valve 212 is performed on the basis of detecting exceedance of one or more engine parameters beyond predetermined safety thresholds. By way of an example, the engine controller 110 detects that a rotational speed of an element of the engine 10 (e.g., the LP turbine 12, the propeller 19, etc.) exceeds a rotational speed threshold. The rotational speed threshold may be a maximum or rated value of the rotational speed of the element of the engine 10 (e.g. based on a torsional limit for the element, or the like), or may be based on a comparison between an actual rotational speed of the element of the engine 10 and an expected rotational speed of the element, for instance based on modeling of the engine 10 or the like. By way of another example, the engine controller 110 detects that an engine temperature exceeds a temperature threshold, which may be a maximum or rated value of the engine temperature, or may be based on an expected engine temperature, for instance based on modeling or the like. By way of a further example, the engine controller 110 detects that an output torque of the engine 10 exceeds an output torque threshold, which may be a maximum or rated value of the output torque of the engine 10, or may be based on an expected output torque of the engine 10, for instance based on modeling or the like. In some cases, the maximum value of the output torque of the engine 10 is based on a shear threshold for an output shaft of the engine 10, a torque limit of the RGB of the engine 10, or the like. In other examples, exceedances of other engine parameters may be used to detect failure of the flow metering valve 212.

The engine controller 110 may first determine one or more engine parameters, for instance via one or more sensors, which may be physical sensors and/or virtual sensors. The engine controller 110 then compares the engine parameter(s) to the safety threshold(s), for instance comparing the engine temperature to the temperature threshold. In this fashion, the engine controller 110 may determine that an engine parameter exceeds the safety threshold. In some other embodiments, detection of failure of the flow metering valve 212 may be performed in a different manner, for instance based on a rate of change of the engine parameter(s), such that the rate of change of one or more of the engine parameters is compared to predetermined rate of change thresholds. By way of another example, an actual fuel flow to the engine 10 is compared against a commanded fuel flow to the engine 10.

Detecting the exceedance of the engine parameter(s) beyond associated safety thresholds indicates to the engine controller 110 that a reduction of the fuel flow to the engine 10 may be required, for instance to maintain operation of the engine 10 within safe or otherwise acceptable operating conditions. Thus, after detecting the exceedance of the engine parameter(s), the engine controller 110 commands the FCU 210 to reduce the fuel flow to the engine 10. The particulars of the command to reduce the fuel flow to the engine 10 may vary between different implementations. In some embodiments, the command may indicate a particular state for the flow metering valve 212 to achieve. In some other embodiments, the command may indicate a relative change in the state of the flow metering valve 212 to be achieved. Other approaches are also considered.

Following the commanding of the FCU 210 to reduce the fuel flow to the engine 10, the engine controller 110 may continue to monitor the engine parameter(s). When the engine controller 110 detects a subsequent exceedance of the engine parameter(s) beyond the safety threshold(s), i.e. after the commanding of the FCU 210 to reduce the fuel flow to the engine 10, the engine controller can conclude that the FCU 210 is malfunctioning, and determine that a fault of the FCU 210 has occurred. In some embodiments, a predetermined time delay for the FCU 210 to implement the reduction in fuel flow to the engine 10 is permitted, such that the detecting of the subsequent exceedance of the engine parameter(s) beyond the safety threshold(s) is only performed after the predetermined time delay is elapsed.

In some embodiments, the detecting of the subsequent exceedance (and, in some cases, of the original exceedance) may be confirmed across multiple channels of the FCU 210 (and of the engine controller 110). The original and/or subsequent exceedance may first be detected on a first channel of the engine controller 110 and of the FCU 210, and is subsequently verified on one or more additional channels of the engine controller 110 and of the FCU. Once one or more additional channels are used to confirm that the original and/or the subsequent exceedance are also detected, the engine controller 110 and/or the FCU 210 can confirm the presence of the exceedance(s), and proceed accordingly.

In response to determining that a fault of the FCU 210 has occurred, the engine controller 110 triggers one or more countermeasures to the fault of the FCU 210. As will be described in greater detail herein below, the particular countermeasures implemented by the engine controller 110 will vary based on the particular configuration of the FCU 210, including based on the implementation of the relief device 214. In addition, the countermeasures may include providing an indication to an operator of the engine 10 (or of a broader system of which the engine 10 forms part). The indication may include information about the nature of the fault of the FCU 210, the particular exceedance of engine parameter(s) that was detected, and the like. The indication may also request that the operator halt fuel flow to the engine 10 via a control means independent of the engine 10. For instance, the avionics system 120 may be provided with a mechanism for halting the flow of fuel to the engine 10, and the indication provided to the operator may request that the operator activate the fuel flow halting mechanism.

In some embodiments, after the countermeasure(s) are implemented, the engine controller 110 may continue to evaluate the engine parameter(s). If at some subsequent time following the implementation of the countermeasure(s), the engine parameter(s) return to acceptable levels (i.e., at or below the safety thresholds), the engine controller 110 may cease the countermeasures, or perform alternative countermeasures, depending on the specific use case and implementation.

Although the foregoing discussion primarily describes the engine controller 110 as detecting the exceedance of the engine parameters and determining of the fault of the FCU 210, it should be understood that the part or all of the functionality attributed to the engine controller 110 may be implemented within other control devices, for instance local controllers within the FCU 210 and/or in other elements of the fuel delivery system 200. Alternatively, or in addition, part or all of the functionality attributed to the engine controller 110 may be implemented as part of the avionics system 120. Other approaches are also considered.

In addition, although the foregoing discussion focuses primarily on fuel delivery systems, it should be understood that the techniques described herein may be applied to other fluid delivery systems. Evaluation of failure of a fluid control system to respond to requests to reduce a flow of the fluid may be performed in various ways, in order to determine that a failure of the fluid control system has occurred. Following that determination, different types of countermeasures may be performed, including analogues to those described herein.

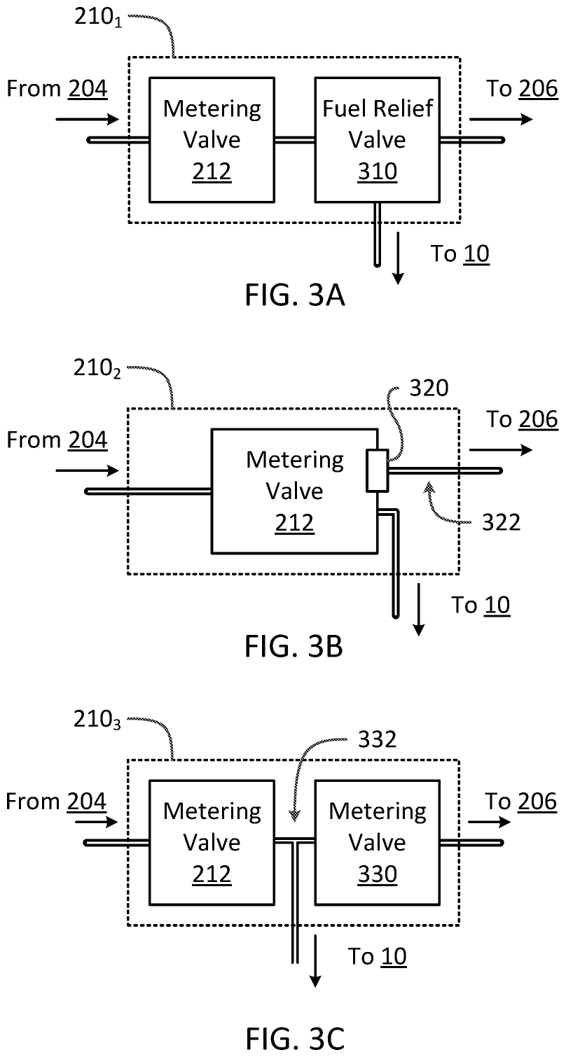

With reference to FIGS. 3A-C, different implementations of the FCU 210 are illustrated. In FIG. 3A, an implementation of the FCU 210, illustrated at 210₁, is composed of the metering valve 212 and a fuel relief valve 310, which is operated separately from the metering valve 310. The fuel relief valve 310 is coupled between the metering valve 212 and the engine 10 (e.g., via the flow distributor 208), and is also coupled to a fuel drain, for example the bypass 206. In another example, the fuel relief valve 310 may be coupled to the flow distributor 208, to the fuel reservoir 202, or to any other suitable element for draining fuel. In this fashion, the fuel flow from the metering valve 212 passes through the fuel relief valve 310 before reaching the engine 10. Under normal operating conditions, the fuel relief valve 310 is deactivated, and passes the fuel flow from the metering valve 212 to the engine 10. However, when a fault of the FCU 210 is determined, the signal issued by the engine controller 110 is a signal to command activation of the fuel relief valve 310 via a control element associated with the fuel relief valve 310 (i.e., independent of the metering valve 212). When activated, the fuel relief valve 310 causes at least part of the fuel flow from the metering valve 212 to be diverted away from the engine 10, for instance causing part of the fuel flow to be returned to the fuel reservoir 202 via the bypass 206.

In FIG. 3B, an implementation of the FCU 210, illustrated at 210₂, includes the metering valve 212 and a drain control 320. The drain control 320 forms part of the metering valve 212, and serves to regulate the flow of fuel to a drain 322 of the FCU 210₂. In some embodiments, the drain control 320 is coupled to the metering valve 212, and in some other embodiments, the drain control 320 is integrated as part of the metering valve 212. For instance, the metering valve 212 is manufactured to include the drain control 320. Under normal operating conditions, the drain control 320 is deactivated, and the fuel flow of the metering valve 212 passes to the engine 10. However, when a fault of the FCU 210 is determined, the signal issued by the engine controller 110 is a signal to command activation of the drain control 320 via a common control element via which the behavior of both the metering valve 212 and the drain control 320 is controlled. For example, the metering valve 212 and the drain control 320 are controlled by way of a common control element (e.g., a solenoid), such that the application of an electrical current to the common control element causes the metering valve 212 to be opened, and the drain control 320 to close. When no electrical current is applied to the common control element, the drain control 320 is caused to open, thus causing at least part of the fuel flow from the metering valve 212 to be diverted away from the engine 10 and returned to the fuel reservoir 202 via the bypass 206, or is otherwise drained and returned to the fuel reservoir 202, for instance via another fuel drain. In some embodiments, actuation of the drain control 320 causes a predetermined fuel flow to be diverted from a total fuel flow to the engine 10. The predetermined fuel flow may be sufficient to reduce the remaining fuel flow to the engine to a predetermined level (e.g., enough to maintain an idle regime for the engine, or a predetermined level of power output above an idle level). Alternatively, the predetermined fuel flow may be sufficient to fully divert the total fuel flow from the engine 10. In some other embodiments, the drain control 320 may be controllable to vary the fuel flow diverted from the engine 10.

In FIG. 3C, an implementation of the FCU 210, illustrated at 210₃, is composed of the metering valve 212 and an additional metering valve 330, which is operated separately from the metering valve 212. The metering valve 330 is coupled between the metering valve 212 and the bypass 206 via a T-shaped connection 332 (though other configurations for connecting the metering valve 330 to the metering valve 212 are also considered). In this fashion, the fuel flow from the metering valve 212 flows to the engine 10 via the T-shaped connection 332. Under normal operating conditions, the metering valve 330 is deactivated, and the fuel flow from the metering valve 212 passes to the engine 10 unimpeded. However, when a fault of the FCU 210 is determined, the signal issued by the engine controller 110 can be a signal to command activation of the metering valve 330 via a control element associated with the fuel relief valve (i.e., independent of the metering valve 212). When activated, the metering valve 330 causes at least part of the fuel flow from the metering valve 212 passing through the T-shaped connection 332 to be diverted away from the engine 10 and through the metering valve 330. The fuel flow diverted through the metering valve 330 may be returned to the fuel reservoir 202 via the bypass 206. In some embodiments, the engine controller 110 may also substantially continuously control the operation of the metering valve 330 in order to regulate the amount of fuel flow diverted away from the engine 10. In this fashion, the overall fuel flow to the engine 10 may still be controlled despite the fault of the FCU 210.

In the illustrated implementations of the FCU 210, the embodiments of the relief device 214—which include the fuel relief valve 310, the drain control 320, and the metering valve 330—serve to divert at least part of the fuel flow from the metering valve 212 away from the engine 10. In this fashion, when the engine controller 110 determines that a fault of the FCU 210 has occurred, the engine controller can issue the signal to trigger the operation of the relief device 214 to accommodate the fault of the FCU 210. It should be noted that the embodiments of the FCU 210 and of the relief device 214 are examples, and that others are considered. In addition, combinations of the relief devices 214 are also considered. For instance, a particular FCU 210 may include both the drain control 320 and the fuel relief valve 310.

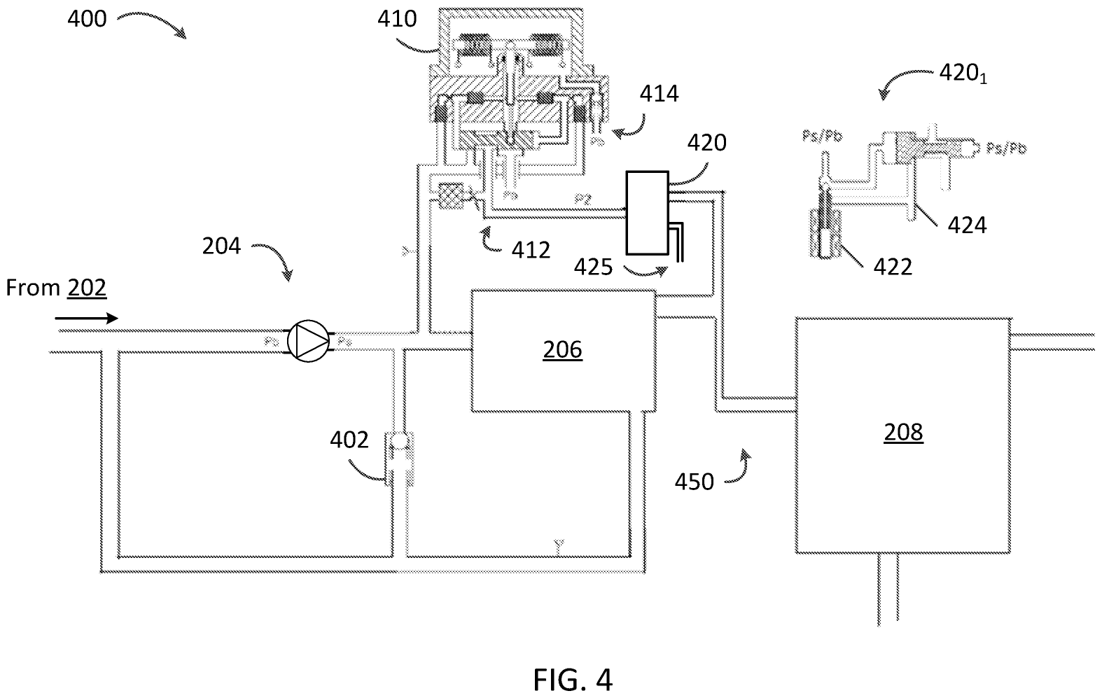

With reference to FIG. 4, an example fuel delivery system 400 is illustrated. The fuel delivery system 400 includes the fuel pump 204, the bypass 206, and the flow distributor 208 (previously illustrated in FIG. 2), as well as a high pressure relief valve 402, a fuel metering valve 410, and a fuel relief valve 420. Fuel flows from the fuel reservoir 202 and is pumped to the remainder of the fuel delivery system 400 via the fuel pump 204. The high pressure relief valve 402 provides an outlet for excess fuel, which is returned to the fuel reservoir 202, or to a location of the fuel delivery system 400 preceding the fuel pump 204. The bypass 206 may also be used to provide an outlet for excess fuel.

The fuel metering valve 410 is provided with an outflow line 412, which conveys fuel from the fuel metering valve 410 to the fuel relief valve 420, and with an drain 414, which provides a conduit to drain fuel when shutting down the engine 10. Under normal conditions, the fuel relief valve 420 permits flow from the fuel metering valve 410 to the flow distributor 208 (and to the bypass 206, when appropriate). When a fault of the FCU 210 is detected, the fuel relief valve 420 is actuated to cause at least part of the fuel flow to be diverted via a drain 245, which routes the fuel, for instance, to the bypass 206. In one example implementation, the fuel relief valve 420 is implemented via valve 420₁, which includes a control element 422 (e.g., a solenoid). When the control element 422 is activated, the valve 420₁ is activated so that at least some of the fuel flow from the fuel metering valve 410 is drained via a drain 424 of the fuel relief valve 420₁. Other implementations are also considered. It should be noted that the location of the fuel relief valve 420 illustrated in FIG. 4 is one example, and other embodiments are also considered. For instance, the fuel relief valve 420 may be located at location 450, at which the fuel relief valve 420 receives flow from the fuel metering valve 410. Other locations for the fuel relief valve 420 are also considered.

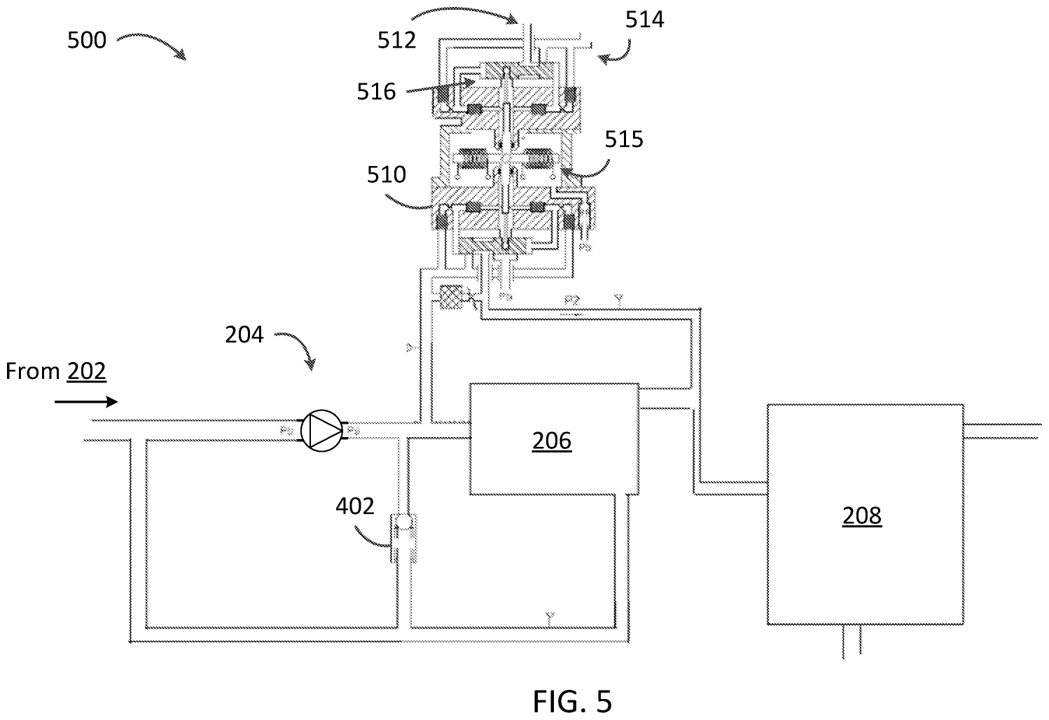

With reference to FIG. 5, an example fuel delivery system 500 is illustrated. The fuel delivery system 500 includes the fuel pump 204, the bypass 206, and the flow distributor 208 (previously illustrated in FIG. 2), as well as the high pressure relief valve 402 and a fuel metering valve 510. Fuel flows from the fuel reservoir 202 and is pumped to the remainder of the fuel delivery system 500 via the fuel pump 204. The high pressure relief valve 402 provides an outlet for excess fuel, which is returned to the fuel reservoir 202, or to a location of the fuel delivery system 500 preceding the fuel pump 204. The bypass 206 may also be used to provide an outlet for excess fuel.

The fuel metering valve 510 is provided with a fuel drain 512, via which fuel may be drained when control elements of the fuel metering valve 510 are not activated (e.g., solenoids 515). The fuel metering valve 510 is also provided with a fuel line 514, which is provided with a static fuel pressure (e.g., via a connection to the main fuel supply of the fuel delivery system 500), and an additional valve 516. The additional valve 516 remains closed, such that it conveys no fuel, so long as the control elements 515 are activated or otherwise commanded by the engine controller 110. When the control elements 515 deactivated (i.e., no current is applied to them, no commanding is performed by the engine controller 110, etc.), the additional valve 516 opens to drain fuel from the fuel metering valve 510. The amount of drained fuel may be a predetermined amount less than the total amount of fuel provided to the fuel metering valve 510, for instance to set an upper bound of the fuel flow delivered by the fuel metering valve 510, or may be commensurate with a maximum amount of fuel flow which the fuel metering valve 510 can provide, thereby diverting the total fuel flow away from the engine 10.

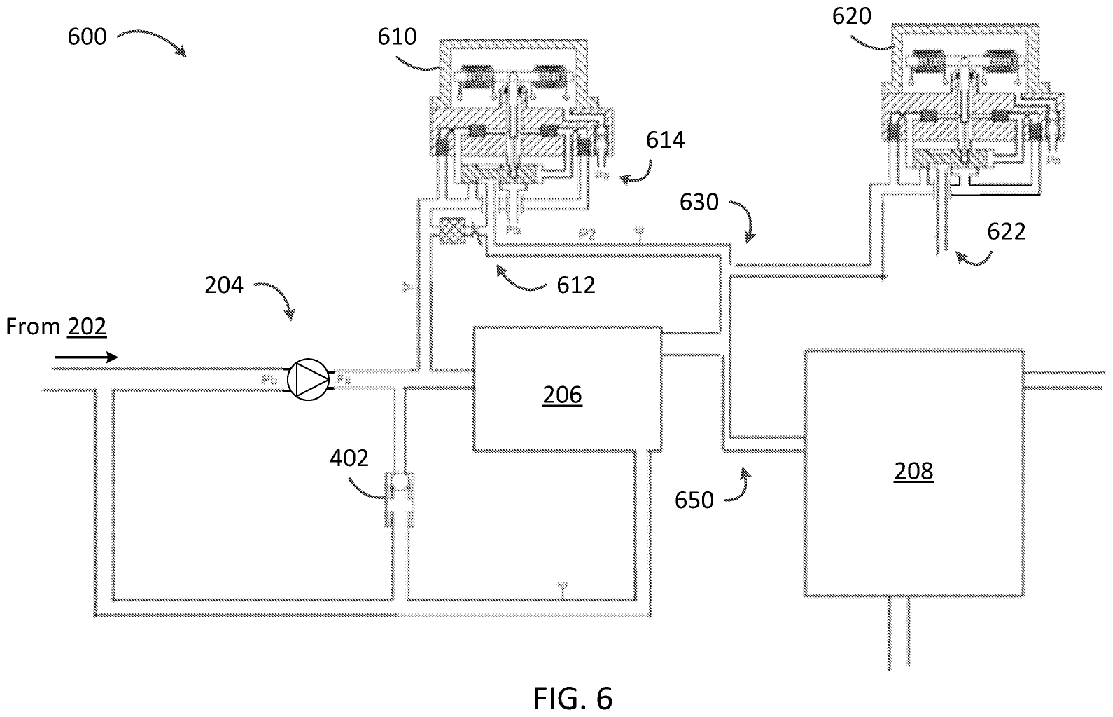

With reference to FIG. 6, an example fuel delivery system 600 is illustrated. The fuel delivery system 600 includes the fuel pump 204, the bypass 206, and the flow distributor 208 (previously illustrated in FIG. 2), as well as the high pressure relief valve 402. The fuel delivery system 600 also includes a first fuel metering valve 610 and a second fuel metering valve 620. Fuel flows from the fuel reservoir 202 and is pumped to the remainder of the fuel delivery system 500 via the fuel pump 204. The high pressure relief valve 402 provides an outlet for excess fuel, which is returned to the fuel reservoir 202, or to a location of the fuel delivery system 600 preceding the fuel pump 204. The bypass 206 may also be used to provide an outlet for excess fuel.

The fuel metering valve 610 may operate substantially similarly to the fuel metering valve 410 of FIG. 4, being provided with an outflow line 612, which conveys fuel from the fuel metering valve 410 to the fuel metering valve 620, and with an drain 614, which provides a conduit to drain fuel when shutting down the engine 10. The fuel metering valve 620 may receive the regulated fuel flow from the metering valve 610 via a connection 630. Under normal conditions, the fuel metering valve 620 remains closed and blocks fuel flow from the fuel metering valve 610 from passing through the fuel metering valve 620. When a fault of the FCU 210 is detected, the engine controller 110 can activate the fuel metering valve 620 to drain at least part of the fuel flow from the metering valve 610 via a drain 622 of the fuel metering valve 620. In some embodiments, the engine controller 110 can modulate the current applied to the fuel metering valve 620 (i.e., to the control elements thereof) in order to modulate the amount of fuel flow drained by the fuel metering valve 620. In this fashion, the engine controller 110 may continue to control the operation of the engine 10 despite the fault of the FCU 210. It should be noted that the location of the fuel metering valve 620 illustrated in FIG. 6 is one example, and other embodiments are also considered. For instance, the fuel metering valve 620 may be located at location 650, at which the fuel metering valve 620 still receives flow from the fuel metering valve 610 via the connector 630. Other locations for the fuel metering valve 620 are also considered.

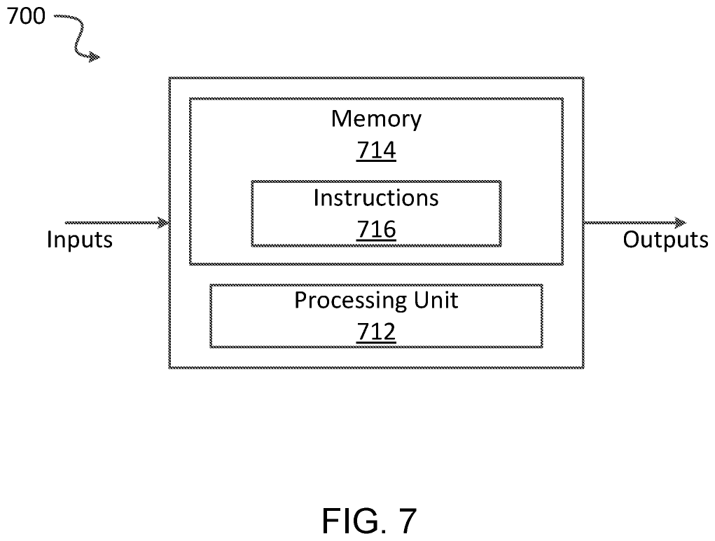

With reference to FIG. 7, an example of a computing device 700 is illustrated. For simplicity, only one computing device 700 is shown; it should nevertheless be understood that multiple computing devices 700 operable to exchange data may be employed, as appropriate. The computing devices 700 may be the same or different types of devices. The engine controller 110 and/or the avionics system 210 may be implemented, in whole or in part, using one or more computing devices 700. Note that the engine controller 110 may be implemented as part of a full-authority digital engine controller (FADEC) or other similar device, including an electronic engine controller (EEC), engine control unit (ECU), propeller electronic controller (PEC), propeller control unit, and the like. In some embodiments, the engine controller 110 is implemented as a Flight Data Acquisition Storage and Transmission system, such as a FAST™ system. The engine controller 110 may be implemented in part in the FAST™ system and in part in the FADEC, EEC, or other similar device. In some embodiments, the EEC, the PEC, and/or any other control devices may be operated or provided in a single-channel configuration, or may be operated or provided in a dual- or multiple-channel configuration. Depending on the configuration of the control device(s), fault detection of the FCU 210 may be performed via a single channel, or via multiple channels. For instance, determination of the fault of the FCU 210 may be performed first via a first channel of the engine controller 110, and then repeated for one or more additional channels of the engine controller 110. Other embodiments may also apply.

The computing device 700 comprises a processing unit 712 and a memory 714 which has stored therein computer-executable instructions 716. The processing unit 712 may comprise any suitable devices configured to implement the functionality described herein, including the various methods described hereinbelow, such that instructions 716, when executed by the computing device 700 or other programmable apparatus, may cause the functions/acts/steps described herein to be executed. The processing unit 712 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 714 may comprise any suitable known or other machine-readable storage medium. The memory 714 may comprise non-transitory computer readable storage medium, for example, but not limited to, an electronic, magnetic, optical, electromagnetic, infrared, or semiconductor system, apparatus, or device, or any suitable combination of the foregoing. The memory 714 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 714 may comprise any storage means (e.g., devices) suitable for retrievably storing machine-readable instructions 716 executable by processing unit 712.

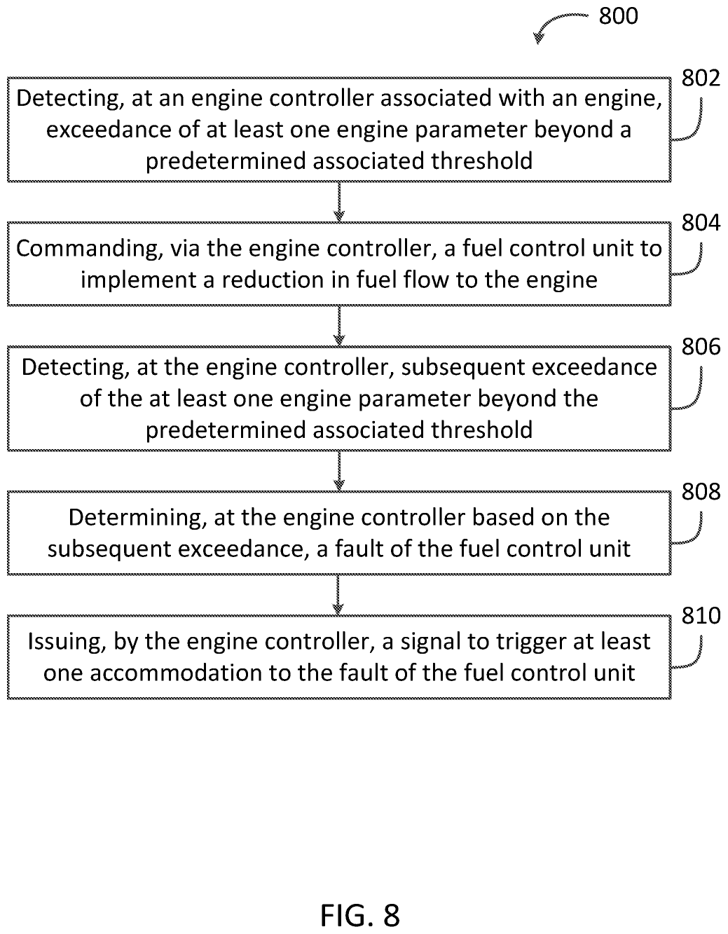

With reference to FIG. 8, a method 800 for fault detection of a fuel control unit of an engine, for instance the FCU 210 of the engine 10, is illustrated. At step 802, the method 800 comprises detecting, at an engine controller associated with the engine 10 (e.g. the engine controller 110), exceedance of at least one engine parameter beyond a safety threshold. The engine controller 110 may detect a rotational speed of an element of the engine 10 exceeding a rotational speed threshold, an engine temperature exceeding a temperature threshold, an output torque of the engine 10 exceeding an output torque threshold, or the like. The detection may be performed in any suitable fashion, including on the basis of values from sensors, values inferred from other sensed values, or the like.

At step 804, the method 800 comprises commanding, via the engine controller 110, the FCU 210 to implement a reduction in fuel flow to the engine 10. The engine controller 110 may command the reduction in fuel flow in any suitable fashion, for instance by requesting that the FCU 210 produce a particular fuel flow, by requesting that the FCU reduce a current fuel flow by a particular amount, or the like.

At step 806, the method 800 comprises detecting, at the engine controller 110, subsequent exceedance of the at least one engine parameter beyond the safety threshold. Step 806 is performed following the commanding of the FCU 210 to implement the reduction in fuel flow to the engine 10. Step 806 may be performed substantially immediately after step 804, after a predetermined time delay has elapsed following step 804, or any other suitable time thereafter. In some embodiments, the predetermined time delay is based on the engine parameter(s) that are found to exceed the safety thresholds. For example, exceedance of the engine temperature beyond a temperature threshold may result in a longer time delay before performing step 806 than exceedance of the engine output torque. The detection of the subsequent exceedance may be performed in a substantially similar manner to the detection of the exceedance at step 802.

At step 808, the method 800 comprises determining, at the engine controller 210 and based on the subsequent exceedance, a fault of the FCU 210. The fault of the FCU 210 may be determined when the subsequent exceedance is detected at step 806; put differently, the engine controller 110 may understand continued or repeated exceedance of the engine parameter(s) beyond the safety threshold(s) after commanding the reduction in fuel flow to mean that the FCU 210 has experienced a fault.

At step 810, the method 800 comprises issuing, by the engine controller 110, a signal to trigger at least one countermeasure to the fault of the FCU 210. The signal to trigger the countermeasure(s) is issued in response to determining the fault of the FCU 210 at step 808. In some embodiments, the countermeasure to the fault of the FCU 210 includes providing an indication of the fault of the FCU 210 to an operator of the engine 10, for instance to a display unit associated with the engine 10, which may form part of the avionics system 120 and be viewable by the operator. For example, the indication may include a prompt to the operator to command a halt of the fuel flow to the engine 10 via an alternative controller separate from the engine controller 110, for instance a controller of the avionics system 120. In some other embodiments, the countermeasure to the fault of the FCU 210 includes commanding the activation of a relief device (e.g., the relief device 214) to divert at least part of the fuel flow away from the engine. The relief device 214 may be controllable by the engine controller 110, such that a state of the relief device 214 can be controlled to regulate operation of the engine 10. The relief device 214 may be independent of a main fuel valve of the engine 10 (e.g., the metering valve 212), or may form part thereof, and be controlled by a common control element.

It should be noted that if no exceedance of the engine parameter(s) is detected at step 802, the method 800 does not proceed to any later step. Similarly, if subsequent exceedance of the engine parameter(s) is not detected at step 806, following the commanding of the FCU 210 to implement the reduction in fuel flow to the engine 10, the method 800 does not proceed to any later step, and no fault of the FCU 210 is determined. The method 800 may return to a previous step and/or to an initial state until exceedance of one or more engine parameter(s) beyond the safety threshold(s) is detected.

The methods and systems for fault detection of a fuel control unit of an engine described herein may be implemented in a high level procedural or object oriented programming or scripting language, or a combination thereof, to communicate with or assist in the operation of a computer system, for example the computing device 700. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 712 of the computing device 700, to operate in a specific and predefined manner to perform the functions described herein, for example those described in the method 800.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the engine controller 110 may continue to evaluate engine parameter(s) after halting countermeasures and, if necessary, repeat the implementation of countermeasures to address further subsequent exceedance of the engine parameter(s). Yet further modifications could be implemented by a person of ordinary skill in the art in view of the present disclosure, which modifications would be within the scope of the present technology.

1. A method for fault detection of a fuel control unit of an engine, comprising:
detecting, at an engine controller associated with the engine, exceedance of at least one engine parameter beyond a safety threshold associated with excessive fuel flow to the engine;
commanding, via the engine controller, the fuel control unit to implement a reduction in the fuel flow to the engine;
following the commanding of the fuel control unit to implement the reduction in the fuel flow to the engine, detecting, at the engine controller, subsequent exceedance of the at least one engine parameter beyond the safety threshold;
determining, at the engine controller based on the subsequent exceedance, a fault of the fuel control unit; and
in response to determining the fault of the fuel control unit, triggering, by the engine controller, at least one countermeasure to the fault of the fuel control unit.

2. The method of claim 1, wherein the triggering of the at least one countermeasure comprises commanding activation of a relief device of the fuel control unit to divert at least part of the fuel flow away from the engine.

3. The method of claim 2, wherein the commanding of the activation of the relief device comprises controlling a state of the relief device to regulate operation of the engine.

4. The method of claim 2, wherein the commanding of the activation of the relief device comprises commanding a control element associated with a fuel relief valve of the fuel control unit to activate the fuel relief valve, wherein the fuel relief valve and the control element are independent of a main fuel valve of the fuel control unit.

5. The method of claim 2, wherein the commanding of the activation of the relief device comprises commanding a common control element associated with the relief device and with a main fuel valve of the fuel control unit to activate the relief device.

6. The method of claim 1, wherein the triggering of the at least one countermeasure comprises providing an indication of the fault of the fuel control unit to a display unit associated with the engine.

7. The method of claim 1, wherein the detecting of the subsequent exceedance of the at least one engine parameter beyond the safety threshold is performed a predetermined time delay after the commanding of the fuel control unit to implement the reduction in the fuel flow to the engine, the predetermined time delay based on the at least one engine parameter.

8. The method of claim 1, wherein the detecting of the exceedance of the at least one engine parameter beyond the predetermined associated threshold, the commanding of the fuel control unit to implement the reduction in the fuel flow to the engine, and the detecting of the subsequent exceedance of the at least one engine parameter beyond the predetermined associated threshold are performed in sequence once for a first channel of the engine controller, and are subsequently performed in sequence for at least one additional channel of the engine controller, and wherein the determining of the fault of the fuel control unit is based on the detecting of the subsequent exceedance on the first channel of the engine controller and on the at least one additional channel of the engine controller.

9. The method of claim 1, wherein the detecting of the exceedance of the at least one engine parameter beyond the predetermined associated threshold comprises detecting at least one of an internal temperature of the engine exceeding a predetermined temperature threshold, a rotational speed of at least one component of the engine exceeding a predetermined rotational speed threshold, and an output torque of the engine exceeding a predetermined torque threshold.

10. The method of claim 1, wherein the detecting of the exceedance of the at least one engine parameter beyond the predetermined associated threshold comprises detecting that a rate of change of the at least one engine parameter exceeds a predetermined associated rate of change threshold.

11. A system for fault detection of a fuel control unit of an engine, comprising:
a processing unit; and
a non-transitory computer-readable medium having stored thereon program instructions executable by the processing unit for causing the system to perform:
detecting, at an engine controller associated with the engine, exceedance of at least one engine parameter beyond a predetermined associated threshold;
commanding, via the engine controller, the fuel control unit to implement a reduction in fuel flow to the engine;
following the commanding of the fuel control unit to implement the reduction in the fuel flow to the engine, detecting, at the engine controller, subsequent exceedance of the at least one engine parameter beyond the predetermined associated threshold;
determining, at the engine controller based on the subsequent exceedance, a fault of the fuel control unit; and
in response to determining the fault of the fuel control unit, issuing, by the engine controller, a signal to trigger at least one countermeasure to the fault of the fuel control unit.

12. The system of claim 11, wherein the triggering of the at least one countermeasure comprises commanding activation of a relief device of the fuel control unit to divert at least part of the fuel flow away from the engine.

13. The system of claim 12, wherein the commanding of the activation of the relief device comprises controlling a state of the relief device to regulate operation of the engine.

14. The system of claim 12, wherein the commanding of the activation of the relief device comprises commanding a control element associated with a fuel relief valve of the fuel control unit to activate the fuel relief valve, wherein the fuel relief valve and the control element are independent of a main fuel valve of the fuel control unit.

15. The system of claim 12, wherein the commanding of the activation of the relief device comprises commanding a common control element associated with the relief device and with a main fuel valve of the fuel control unit to activate the relief device.

16. The system of claim 11, wherein the triggering of the at least one countermeasure comprises providing an indication of the fault of the fuel control unit to a display unit associated with the engine.

17. The system of claim 11, wherein the detecting of the subsequent exceedance of the at least one engine parameter beyond the safety threshold is performed a predetermined time delay after the commanding of the fuel control unit to implement the reduction in the fuel flow to the engine, the predetermined time delay based on the at least one engine parameter.

18. The system of claim 11, wherein the detecting of the exceedance of the at least one engine parameter beyond the predetermined associated threshold, the commanding of the fuel control unit to implement the reduction in the fuel flow to the engine, and the detecting of the subsequent exceedance of the at least one engine parameter beyond the predetermined associated threshold are performed in sequence once for a first channel of the engine controller, and are subsequently performed in sequence for at least one additional channel of the engine controller, and wherein the determining of the fault of the fuel control unit is based on the detecting of the subsequent exceedance on the first channel of the engine controller and on the at least one additional channel of the engine controller.

19. The system of claim 11, wherein the detecting of the exceedance of the at least one engine parameter beyond the predetermined associated threshold comprises detecting at least one of an internal temperature of the engine exceeding a predetermined temperature threshold, a rotational speed of at least one component of the engine exceeding a predetermined rotational speed threshold, and an output torque of the engine exceeding a predetermined torque threshold.

20. The system of claim 11, wherein the detecting of the exceedance of the at least one engine parameter beyond the predetermined associated threshold comprises detecting that a rate of change of the at least one engine parameter exceeds a predetermined associated rate of change threshold.
